(19) United States
(12) Patent Application Publication
(10) Pub. No.: US 2015/0151391 A1
(43) Pub. Date: Jun. 4, 2015

(54) SCREWING MACHINE AND TROUBLE SHOOTING METHOD THEREOF

(71) Applicant: Quanta Computer Inc., Taoyuan Shien (TW)

(72) Inventors: Hsin-Hung KUO, Taoyuan County (TW); Lung-Chiang CHU, Taipei City (TW); Tung-Chien TAI, Taoyuan County (TW)

(73) Assignee: Quanta Computer Inc., Taoyuan Shien (TW)

(21) Appl. No.: 14/300,478

(22) Filed: Jun. 10, 2014

(30) Foreign Application Priority Data
Dec. 3, 2013 (TW) 102144250

(51) Int. Cl. B23P 19/06

(52) U.S. Cl. CPC B23P 19/06

(57) ABSTRACT

The disclosure provides a screwing machine including a machine frame, a screwing device, a suction device, a negative pressure judgment device, and a screw removal device. The screwing device is moveably located on the machine frame. The screwing device has a nozzle, and the screwing device is configured to fasten a screw into a workpiece. The suction device has a connecting tube communicated with the nozzle of the screwing device. When the suction device sucks the screw, the suction device drains an air inside the nozzle to enable a negative pressure inside the nozzle. Further, the negative pressure judgment device is communicated with the air inside the nozzle.

### RELATED APPLICATIONS

This application claims priority to Taiwan Application Serial Number 102144250, filed Dec. 03, 2013, which is herein incorporated by reference.

### BACKGROUND

1. Technical Field

The present disclosure relates to a screwing machine. More particularly, the present disclosure relates to a screwing machine having a screw removal device.

2. Description of Related Art

A conventional suction-screwing machine generally operates as follows. In the conventional suction-screwing machine, a negative pressure is applied to suck a screw from a screw provider and then performs fastening process. The sucking and fastening processes are constantly repeated in the operation. A screwdriver is inside a nozzle of the suction-screwing machine.

However, when the suction-screwing machine repeats the sucking and fastening processes, suction problems may inevitably occur due to a misalignment of the screw provider, tolerance of the screws, mismatch between the nozzle and the screw, and so on. In case of conventional suction-screwing machine fails to fasten a screw resulting from these reasons, additional human resources and cost are required to solve the problem.

### SUMMARY

The disclosure provides a screwing machine including a machine frame, a screwing device, a suction device, a negative pressure judgment device, and a screw removal device. The screwing device is moveably located on the machine frame. The screwing device has a nozzle, and the screwing device is configured to fasten a screw into a workpiece. The suction device has a connecting tube communicated with the nozzle of the screwing device. When the suction device sucks the screw, the suction device drains an air inside the nozzle to enable a negative pressure inside the nozzle. The negative pressure judgment device is communicated with the air inside the nozzle. When the nozzle sucks the screw, the negative pressure judgment device determines whether a pressure value of the air inside the nozzle matches a default value. When the negative pressure judgment device determines that the air inside the nozzle matches the default value, the screwing device fastens the screw into the workpiece. The screw removal device includes an accommodation space, an opening, and a resilient stopper located at the opening. When the negative pressure judgment device determines that the air inside the nozzle does not match the default value, the screwing device moves to the screw removal device and makes the nozzle be aligned with and contact the resilient stopper, such that the resilient stopper removes the screw from the nozzle to make the screw drop into the accommodation space through the opening.

In an embodiment of the present disclosure, the resilient stopper is a brush.

The present disclosure further provides another screwing machine including a machine frame, a screwing device, a suction device, a blowing device, a negative pressure judgment device, and a screw removal device. The screwing device is moveably located on the machine frame. The screwing device has a nozzle, and the screwing device is configured to fasten a screw into a workpiece. The suction device has a connecting tube communicated with the nozzle of the screwing device. When the suction device sucks the screw, the suction device drains an air inside the nozzle to enable a negative pressure inside the nozzle. The blowing device is communicated with the air inside the nozzle through the connecting tube. The negative pressure judgment device is communicated with the air inside the nozzle. When the nozzle sucks the screw, the negative pressure judgment device determines whether a pressure value of the air inside the nozzle matches the default value. When the negative pressure judgment device determines that the air inside the nozzle matches the default value, the screwing device fastens the screw into the workpiece. The screw removal device includes an accommodation space and an opening. When the negative pressure judgment device determines that the air inside the nozzle does not match the default value, the screwing device moves to the screw removal device, and the blowing device pumps an air into the nozzle to blow off the screw from the nozzle, such that the screw drops into the accommodation space through the opening.

In an embodiment of the present disclosure, the screwing machine further includes two solenoid valves to respectively switch the suction device and the blowing device.

In an embodiment of the present disclosure, the screwing device further includes a screwdriver located above the nozzle. When the screwing device fastens the screw into the workpiece, the screwdriver passes through the nozzle and operatively connects the screw. Then, the screwdriver drives the screw to rotate and makes the screw be fastened into the workpiece.

The present disclosure further provides an automatically troubleshooting method including following steps: (A) utilizing a nozzle of a screwing device to suck a screw, and the screwing device is configured to fasten the screw into a workpiece; (B) utilizing a negative pressure judgment device to determine whether a pressure value of the air inside the nozzle matches the default value, when the negative pressure judgment device determines that the air inside the nozzle matches a default value, the screwing device drives the screw into the workpiece; and (C) moving the screwing device to a screw removal device to remove the screw when the negative pressure judgment device determines that the air inside the nozzle does not match the default value.

In an embodiment of the present disclosure, the step (A) further includes: utilizing a suction device of the screwing machine to drain out the air inside the nozzle to make the pressure inside the nozzle be negative, moving the screwing device to make the nozzle be aligned with and to suck the screw, moving the screwing device to align the screw with the workpiece, and utilizing a screwdriver of the screwing device to drive the screw to rotate and make the screw be fastened into the workpiece.

In an embodiment of the present disclosure, the step (B) further includes: when the screwing device moves to the screw removal device to remove the screw, aligning and contacting the nozzle with a resilient stopper of the screw removal device, such that the resilient stopper removes the screw of the nozzle, and thus the screw drops into an accommodation space of the screw removal device through an opening of the screw removal device.

In an embodiment of the present disclosure, the step (B) further includes: when the screwing device moves to the screw removal device removes the screw, utilizing a blowing device to pump an air into the nozzle to blow off the screw from the nozzle, such that the screw drops into an accommodation space of the screw removal device through an opening of the screw removal device.

Accordingly, the disclosure provides the screwing machine and the automatically troubleshooting method to effectively improve a problem that w the screwing machine always needs a staff to solve the faults occurred when the screwing machine fastens the screws. The screwing machine has a screw removal device. When the negative pressure judgment device determines that the pressure of the air inside the nozzle does not match the default value, the screwing device moves to the screw removal device and removes off the screw from the nozzle. As a result, it does not need the staff to remove off the screw from the nozzle. The disclosure can be used in mass production, increase the producing yield, save human force, and increase the value of the product consequently.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic view of the screwing machine according to an embodiment of the present disclosure;

FIG. 2 is a schematic view showing that the screwing device removes a screw to the screw removal device;

FIG. 3 is a schematic view showing that the screwing device removes the screw to the screw removal device; and

FIG. 4 is a flow chart of an automatically troubleshooting method.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

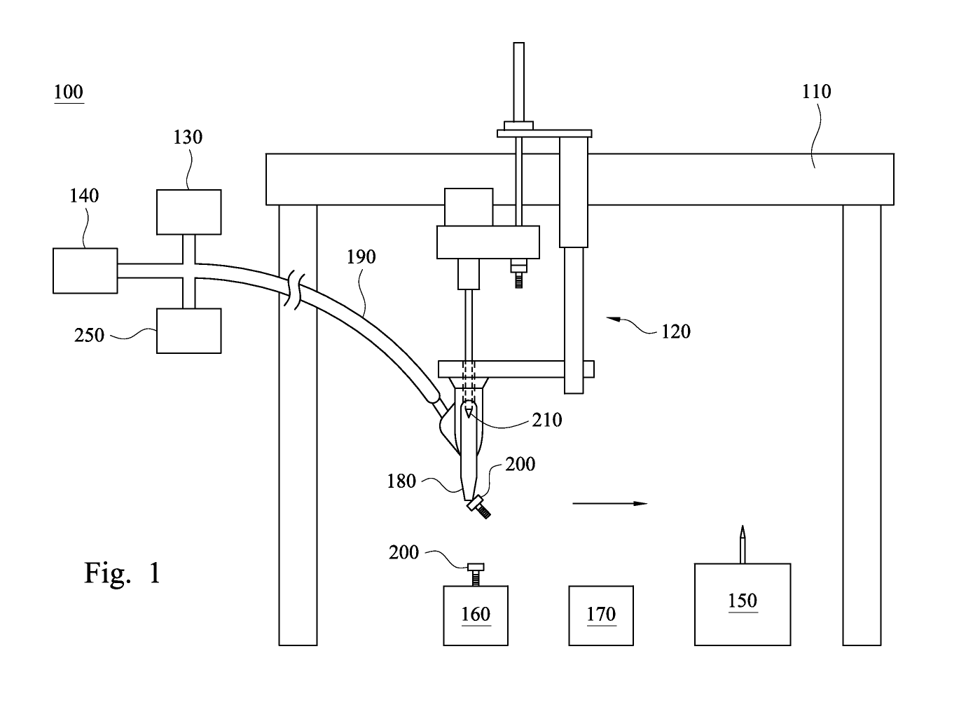

In order to solve a problem that a conventional screwing machine may cause a screwing problem, the present disclosure provides a screwing machine to improve the problem. FIG. 1 is a schematic view of the screwing machine 100 according to an embodiment of the present disclosure. The screwing machine 100 includes a machine frame 110, a screwing device 120, a suction device 130, a negative pressure judgment device 140 and a screw removal device 150. The screwing device 120 is located on the machine frame 110 and can move left or right on the machine frame, so as to be aligned with a screw providing machine 160, a workpiece 170 to be fastened with a screw 200, or the screw removal device 150. The screwing device 120 has a nozzle 180, and the screwing device 120 is configured to fasten the screw 200 into the workpiece 170. The suction device 130 has a connecting tube 190 communicated with the nozzle 180 of the screwing device 120. Consequently, the suction device 130 and the nozzle 180 are communicated.

When the nozzle 180 sucks the screw 200, the screwing device 120 is aligned with the screw 200 of the screw providing machine 160, the suction device 130 drains an air inside the nozzle 180, to enable a negative pressure inside the nozzle 180. Then, the nozzle 180 moves down to suck the screw 200. When the nozzle 180 sucks the screw 200 regularly, a pressure value of the air inside the nozzle 180 is in a certain range of negative pressure value. When the nozzle 180 sucks the screw 200 irregularly, an air leaks into the nozzle 180 from outside. Consequently, the pressure value of the air inside the nozzle 180 is greater than the range of negative pressure value. In brief, the disclosure utilizes the negative pressure judgment device 140 to determine the pressure of the air inside the nozzle, so as to determine whether the nozzle 180 sucks the screw 200 regularly.

When the negative pressure judgment device 140 determines the pressure of the air inside the nozzle 180 matches a default value, the screwing device 120 moves to be above the workpiece 170 and performs fastening. The screwing device 120 includes a screwdriver 210 located on the nozzle 180. When the screwing device 120 fastens the screw 200 into the workpiece 170, the screwdriver 210 passes through the nozzle 180 and operatively connects the screw 200, and then the screwdriver 210 drives the screw 200 to rotate and makes the screw be fastened into the workpiece 170.

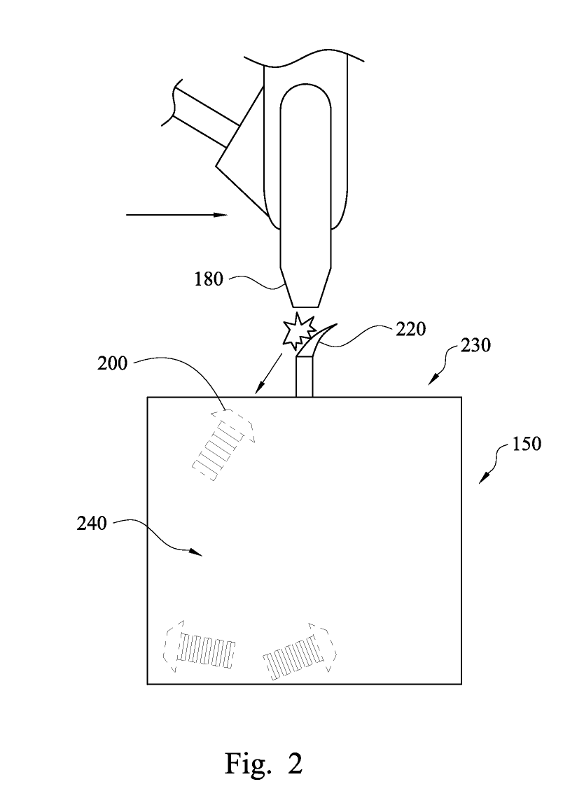

FIG. 2 is a schematic view showing that the screwing device removes a screw to the screw removal device. As shown in FIG. 1 and FIG. 2, when the nozzle 180 sucks the screw 200 and then the negative pressure judgment device 140 determines that a suction status of the nozzle 180 is irregular, the screwing device 120 moves to the screw removal device 150 to make the nozzle 180 be aligned with and contact to a resilient stopper 220, so that the resilient stopper 220 removes the screw 200 of the nozzle 180. After that, the screw 200 drops into the accommodation space 240 through the opening 230. The nozzle 180 could be magnetic (so as to position the screw 200 more accurately), so that even a suction force of the nozzle 180 is decreased or is eliminated; the screw 200 may not falls. In this case, it needs an external force to removes the screw 200. After the screw 200 is removed, the screwing device 120 moves to be above the screw providing machine 160 to suck the screw 200 and to perform the fastening to the workpiece 170. In an embodiment of the present disclosure, the resilient stopper is a brush.

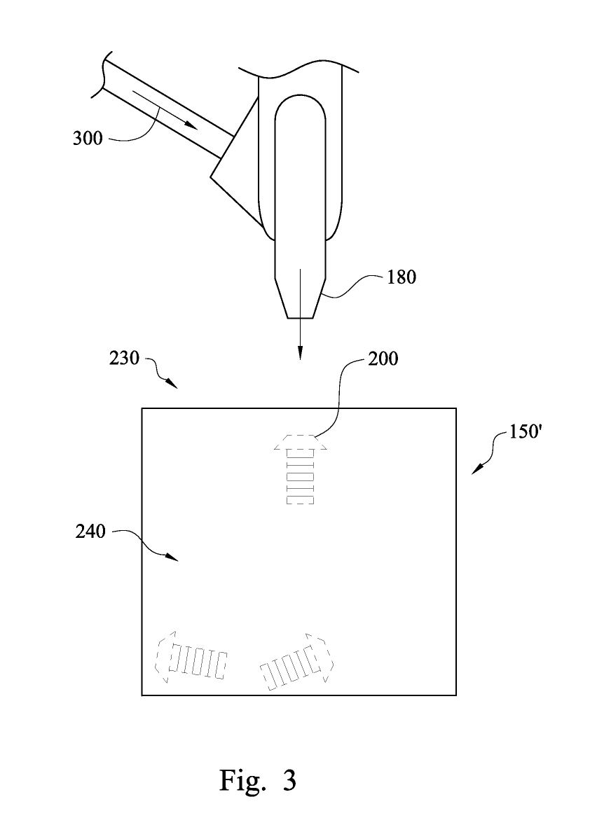

FIG. 3 is a schematic view showing that the screwing device removes the screw to the screw removal device. As shown in FIG. 1 and FIG. 3, in the embodiment of the present disclosure, the screwing machine 100 further includes a blowing device 250. The blowing device 250 is communicated with the connecting tube 190 and the air inside the nozzle 180. In an embodiment of the present disclosure, the screw removal device 150′ includes an accommodation space 240 and an opening 230. When the negative pressure judgment device 140 determines that the pressure of the air inside the nozzle 180 does not match the default value, the screwing device 120 moves to the screw removal device 150′. Then, the blowing device 250 pumps an air from outside into the nozzle 180 along a direction 300 and blows off the screw 200 on the nozzle 180, such that the screw 200 drops into the opening 230 through the accommodation space 240. In an embodiment of the present disclosure, the screwing machine 100 further includes two solenoid valves to respectively switch the suction device 130 and the blowing device 250.

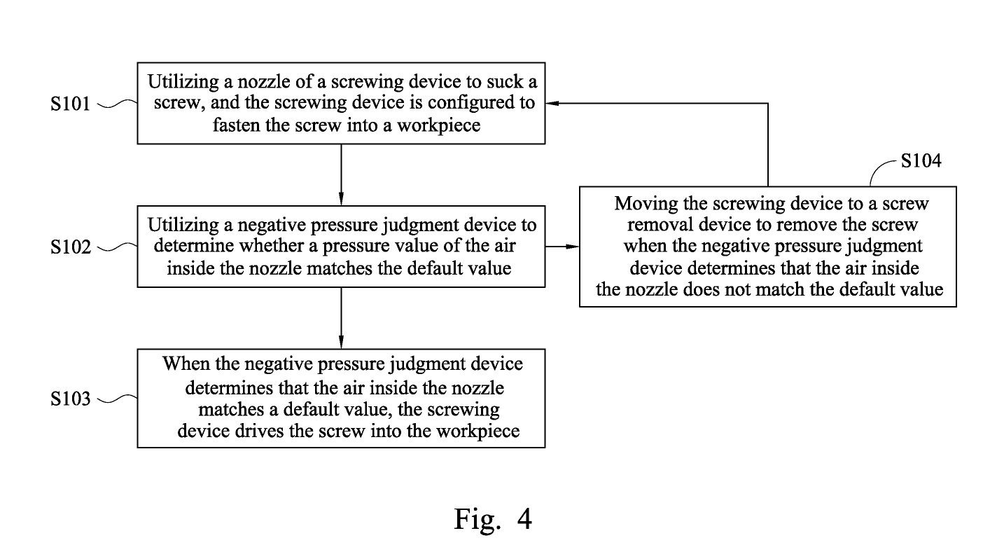

FIG. 4 is a flow chart of an automatically troubleshooting method. The present disclosure further provides an automatically troubleshooting method including steps S101-S104.

Step S101: utilizing a nozzle of a screwing device to suck a screw, and the screwing device is configured to fasten the screw into a workpiece.

Step S102: utilizing a negative pressure judgment device to determine whether a pressure value of the air inside the nozzle matches the default value. In the step S103, when the negative pressure judgment device determines that the air inside the nozzle matches a default value, the screwing device drives the screw into the workpiece.

Step S104, moving the screwing device to a screw removal device to remove the screw when the negative pressure judgment device determines that the air inside the nozzle does not match the default value.

After the screw is removed, the screwing device is back to the step S101 to perform fastening. The steps described above and relative actions thereof are described in the embodiment of FIG. 1 and are not described again. In the step S104, there are two aspects of removing the screw. In one aspect, the method for step S104 to remove the screw is: when the screwing device moves to the screw removal device to remove the screw, the nozzle is aligned with and contact to a resilient stopper of the screw removal device, so that the resilient stopper removes off the screw from the nozzle. Accordingly, the screw removal device drops into an accommodation space through an opening of the screw removal device. The aspect described above and relative actions thereof are described in the embodiment of FIG. 2 and are not described again. In another aspect, the method for step S104 to remove the screw is: when the screwing device moves to the screw removal device to remove the screw, utilizing a blowing device to pump an air into the nozzle, and blowing off the screw from the nozzle, so that the screw drops into an opening of the screw removal device through an accommodation space of the screw removal device. The aspect described above and relative actions thereof are described in the embodiment of FIG. 3 and are not described again.

In an embodiment of the present disclosure, the step S101 further includes: utilizing a suction device of the screwing machine to drain out the air inside the nozzle to make the pressure inside the nozzle be negative, moving the screwing device to make the nozzle be aligned with and to suck the screw, moving the screwing device to align the screw with the workpiece, and utilizing a screwdriver of the screwing device to drive the screw to rotate and make the screw be fastened into the workpiece.

Accordingly, the disclosure provides the screwing machine and the automatically troubleshooting method to effectively improve a problem that w the screwing machine always needs a staff to solve the faults occurred when the screwing machine fastens the screws. The screwing machine has a screw removal device. When the negative pressure judgment device determines that the pressure of the air inside the nozzle does not match the default value, the screwing device moves to the screw removal device and removes off the screw from the nozzle. As a result, it does not need the staff to remove off the screw from the nozzle. The disclosure can be used in mass production, increase the producing yield, save human force, and increase the value of the product consequently.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A screwing machine, comprising:
a machine frame;
a screwing device moveably located on the machine frame, the screwing device having a nozzle, and the screwing device being configured to fasten a screw into a workpiece;
a suction device having a connecting tube communicated with the nozzle of the screwing device, wherein when the suction device sucks the screw, the suction device drains an air inside the nozzle to enable a negative pressure inside the nozzle;
a negative pressure judgment device communicated with the air inside the nozzle, wherein when the nozzle sucks the screw, the negative pressure judgment device determines whether a pressure value of the air inside the nozzle matches a default value; and when the negative pressure judgment device determines that the air inside the nozzle matches the default value, the screwing device fastens the screw into the workpiece; and
a screw removal device comprising an accommodation space, an opening, and a resilient stopper located at the opening, wherein when the negative pressure judgment device determines that the air inside the nozzle does not match the default value, the screwing device moves to the screw removal device and makes the nozzle be aligned with and contact the resilient stopper, such that the resilient stopper removes the screw from the nozzle to make the screw drop into the accommodation space through the opening.

2. The screwing machine of claim 1, wherein the resilient stopper is a brush.

3. A screwing machine, comprises:
a machine frame;
a screwing device moveably located on the machine frame, the screwing device having a nozzle, and the screwing device being configured to fasten a screw into a workpiece;
a suction device having a connecting tube communicated with the nozzle of the screwing device, wherein when the suction device sucks the screw, the suction device drains an air inside the nozzle to enable a negative pressure inside the nozzle;
a blowing device communicated with the air inside the nozzle through the connecting tube;
a negative pressure judgment device communicated with the air inside the nozzle, wherein when the nozzle sucks the screw, the negative pressure judgment device determines whether a pressure value of the air inside the nozzle matches the default value; and when the negative pressure judgment device determines that the air inside the nozzle matches the default value, the screwing device fastens the screw into the workpiece; and
a screw removal device comprising an accommodation space and an opening, wherein when the negative pressure judgment device determines that the air inside the nozzle does not match the default value, the screwing device moves to the screw removal device, and the blowing device pumps an air into the nozzle to blow off the screw from the nozzle, such that the screw drops into the accommodation space through the opening.

4. The screwing machine of claim 3, further comprising two solenoid valves to respectively switch the suction device and the blowing device.

5. The screwing machine of claim 1, wherein the screwing device further comprises a screwdriver located above the nozzle; when the screwing device fastens the screw into the workpiece, the screwdriver passes through the nozzle and operatively connects the screw, and then the screwdriver drives the screw to rotate and makes the screw be fastened into the workpiece.

6. An automatically troubleshooting method, comprising:
(A) utilizing a nozzle of a screwing device to suck a screw, wherein the screwing device is configured to fasten the screw into a workpiece;
(B) utilizing a negative pressure judgment device to determine whether a pressure value of the air inside the nozzle matches the default value; when the negative pressure judgment device determines that the air inside the nozzle matches a default value, the screwing device drives the screw into the workpiece; and
(C) moving the screwing device to a screw removal device to remove the screw when the negative pressure judgment device determines that the air inside the nozzle does not match the default value.

7. The automatically troubleshooting method of claim 6, wherein the step (A) further comprises:
utilizing a suction device of the screwing machine to drain out the air inside the nozzle to make the pressure inside the nozzle be negative, moving the screwing device to make the nozzle be aligned with and to suck the screw, moving the screwing device to align the screw with the workpiece, and utilizing a screwdriver of the screwing device to drive the screw to rotate and make the screw be fastened into the workpiece.

8. The automatically troubleshooting method of claim 6, wherein the step (B) further comprising:
when the screwing device moves to the screw removal device to remove the screw, aligning and contacting the nozzle with a resilient stopper of the screw removal device, such that the resilient stopper removes the screw of the nozzle, and thus the screw drops into an accommodation space of the screw removal device through an opening of the screw removal device.

9. The automatically troubleshooting method of claim 6, wherein the resilient stopper is a brush.

10. The automatically troubleshooting method of claim 6, wherein the step (B) further comprising:
when the screwing device moves to the screw removal device removes the screw, utilizing a blowing device to pump an air into the nozzle to blow off the screw from the nozzle, such that the screw drops into an accommodation space of the screw removal device through an opening of the screw removal device.
